(19) United States
(12) Patent Application Publication
(10) Pub. No.: US 2025/0133178 A1
(43) Pub. Date: Apr. 24, 2025

(54) COLORIMETRIC SHEET PRODUCTION METHOD, COLORIMETRIC SHEET PRODUCTION PROGRAM, PRINTER PRODUCTION METHOD, AND PRINTER PRODUCTION PROGRAM

(71) Applicant: SEIKO EPSON CORPORATION, Tokyo (JP)

(72) Inventor: Ayako KOBAYASHI, Okaya (JP)

(21) Appl. No.: 18/919,511

(22) Filed: Oct. 18, 2024

(30) Foreign Application Priority Data
Oct. 20, 2023 (JP) 2023-180757

(51) Int. Cl. H04N 1/60; H04N 1/23; H04N 1/393

(52) U.S. Cl. CPC H04N 1/6033; H04N 1/2323; H04N 1/393

(57) ABSTRACT

A colorimetric sheet production method includes receiving designation of a size of a medium, and producing a colorimetric sheet by printing a color chart. When a size of a colorimetry jig in a first direction is A, and a value corresponding to a size of the colorimeter is B, and in a case in which the sizes are, in order from largest, the first size, the second size, A-B, and the third size, when the size of the medium is the first size and the second size, the color chart is printed in which the same number of patches are arranged in the first direction, and when the size of the medium in the first direction is the third size, the color chart is printed in which the number of the patches arranged in the first direction is smaller than the number in a case of the second size.

The present application is based on, and claims priority from JP Application Serial Number 2023-180757, filed Oct. 20, 2023, the disclosure of which is hereby incorporated by reference herein in its entirety.

### BACKGROUND

### 1. Technical Field

The present disclosure relates to a colorimetric sheet production method, a colorimetric sheet production program, a printer production method, and a printer production program.

### 2. Related Art

There has been known a technique for printing a color chart including patches of a plurality of colors using a printer. For example, Japanese Patent Application Laid-Open No. 2020-35239 discloses a technique of printing an image indicating a color measurement start position and a color measurement start orientation of a colorimeter, on a color chart for each of a forward path and a backward path of the colorimeter.

However, according to the known technique, the size of the color chart is fixed and cannot be changed flexibly.

### SUMMARY

A colorimetric sheet production method to achieve the object described above includes receiving designation of a size of a medium from among a plurality of sizes including a first size, a second size, and a third size, and producing a colorimetric sheet by printing, using a printer, a color chart on the medium having the designated size, wherein, when a size of a colorimetry jig in a first direction in which a colorimeter is moved using the colorimetry jig is A, and a value corresponding to a size of the colorimeter is B, and in a case in which the sizes are, in order from largest, the first size, the second size, A-B, and the third size, when the size of the medium in the first direction is the first size and the second size, the color chart is printed in which the same number of patches are arranged in the first direction, and when the size of the medium in the first direction is the third size, the color chart is printed in which the number of the patches arranged in the first direction is smaller than the number in a case of the second size.

A colorimetric sheet production method for achieving the object described above includes receiving designation of a size of a medium from among a plurality of sizes including a first size, a second size, and a third size, and producing a colorimetric sheet by printing, using a printer, a color chart on the medium having the designated size, wherein a size of color measurement in a first direction, in which a colorimeter is moved using a colorimetry jig, when the color measurement is started from one end portion in the first direction and ended at another end portion in the first direction is a threshold value, in a case in which the sizes are, in order from largest, the first size, the second size, the threshold value, and the third size, when the size of the medium in the first direction is the first size and the second size, the color chart is printed in which the same number of patches are aligned in the first direction, and when the size of the medium in the first direction is the third size, the color chart is printed in which the number of the patches arranged in the first direction is smaller than the number in a case of the second size.

A printer production method achieving the object described above includes receiving designation of a size of a medium from among a plurality of sizes including a first size, a second size, and a third size, producing a colorimetric sheet by printing, using a printer, a color chart on the medium having the designated size, causing a user to manually perform color measurement on the color chart of the colorimetric sheet, creating adjusted color data based on a result of the color measurement, and storing the adjusted color data in the printer, wherein when a size of a colorimetry jig in a first direction in which a colorimeter is moved using the colorimetry jig is A, and a value corresponding to a size of the colorimeter is B, and in a case in which the sizes are, in order from largest, the first size, the second size, A-B, and the third size, when the size of the medium in the first direction is the first size and the second size, the color chart is printed in which the same number of patches are arranged in the first direction, and when the size of the medium in the first direction is the third size, the color chart is printed in which the number of patches arranged in the first direction is smaller than the number in a case of the second size.

A non-transitory computer-readable storage medium storing a colorimetric sheet production program for achieving the object described above causes a computer to function to receive designation of a size of a medium from among a plurality of sizes including a first size, a second size, and a third size, and produce a colorimetric sheet by printing, using a printer, a color chart on the medium having the designated size, wherein when a size of a colorimetry jig in a first direction in which a colorimeter is moved using the colorimetry jig is A, and a value corresponding to a size of the colorimeter is B, and in a case in which the sizes are, in order from largest, the first size, the second size, A-B, and the third size, when the size of the medium in the first direction is the first size and the second size, the color chart is printed in which the same number of patches are arranged in the first direction, and when the size of the medium in the first direction is the third size, the color chart is printed in which the number of patches arranged in the first direction is smaller than the number in a case of the second size.

A non-transitory computer-readable storage medium storing a colorimetric sheet production program achieving the object described above causes a computer to function to receive designation of a size of a medium from among a plurality of sizes including a first size, a second size, and a third size, and produce a colorimetric sheet by printing, using a printer, a color chart on the medium having the designated size, wherein a size of color measurement in a first direction, in which a colorimeter is moved using a colorimetry jig, when the color measurement is started from one end portion in the first direction and ended at another end portion in the first direction is a threshold value, and in a case in which the sizes are, in order from largest, the first size, the second size, the threshold value, and the third size, when the size of the medium in the first direction is the first size and the second size, the color chart is printed in which the same number of patches are arranged in the first direction, and when the size of the medium in the first direction is the third size, the color chart is printed in which the number of the patches arranged in the first direction is smaller than the number in a case of the second size.

A non-transitory computer-readable storage medium storing a printer production program achieving the object described above causes a computer to function to receive designation of a size of a medium from among a plurality of sizes including a first size, a second size, and a third size, produce a colorimetric sheet by printing, using a printer, a color chart on the medium having the designated size, cause a user to manually perform color measurement on the color chart of the colorimetric sheet, create adjusted color data based on a result of the color measurement, and store the adjusted color data in the printer, wherein when a size of a colorimetry jig in a first direction in which a colorimeter is moved using the colorimetry jig is A, and a value corresponding to a size of the colorimeter is B, and in a case in which the sizes are, in order from largest, the first size, the second size, A-B, and the third size, when the size of the medium in the first direction is the first size and the second size, the color chart is printed in which the same number of patches are arranged in the first direction, and when the size of the medium in the first direction is the third size, the color chart is printed in which the number of the patches arranged in the first direction is smaller than the number in a case of the second size.

### BRIEF DESCRIPTION OF THE DRAWINGS

FIG. 1 is a diagram illustrating an overall configuration of a system for producing a colorimetric sheet.

FIG. 2 is a view illustrating a configuration of a computer.

FIG. 3 is a view illustrating a configuration of a printer.

FIG. 4 is a diagram illustrating a configuration of a colorimeter.

FIG. 5 is a diagram illustrating how manual color measurement is performed using a colorimetry jig.

FIG. 6 is a diagram illustrating how manual color measurement is performed using the colorimetry jig.

FIG. 7 is a diagram illustrating an example of the colorimetric sheet.

FIG. 8 is a flowchart of colorimetric sheet production processing.

FIG. 9 is a flowchart of the colorimetric sheet production processing.

FIG. 10 is a diagram illustrating an example of a user interface.

FIG. 11 is a diagram illustrating an example of the user interface.

FIG. 12 is a diagram illustrating an example of the user interface.

FIG. 13 is a diagram illustrating an example of the user interface.

FIG. 14 is a diagram for explaining a colorimetric sheet with the maximum number of patches in a first direction.

FIG. 15 is a diagram for explaining a colorimetric sheet S with priority on ease of color measurement operation.

FIG. 16 is a diagram illustrating an example of color measurement using the colorimetry jig.

FIG. 17 is a diagram illustrating an example of the color measurement using the colorimetry jig.

FIG. 18 is a diagram illustrating an example of the color measurement using the colorimetry jig.

FIG. 19 is a diagram illustrating an example of the color measurement using the colorimetry jig.

FIG. 20 is a diagram illustrating an example of the color measurement using the colorimetry jig.

FIG. 21 is a flowchart of printer production processing.

### DESCRIPTION OF EMBODIMENTS

Hereinafter, embodiments of the present disclosure will be described in the following order.
(1) System Configuration:
(1-1) Configuration of Computer:
(1-2) Configuration of Printer:
(1-3) Configuration of Colorimeter:
(2) Method for Producing Colorimetric Sheet:
(3) Method of Producing Printer:
(4) Other Embodiments:
(1) System Configuration:

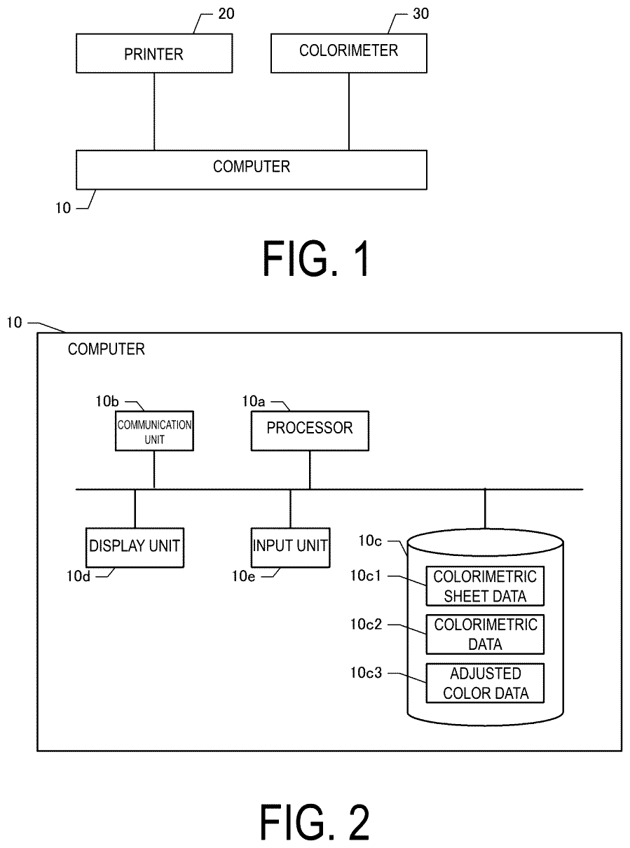

FIG. 1 is a configuration diagram of a system capable of producing a colorimetric sheet and producing a printer. The system includes a computer 10, a printer 20, and a colorimeter 30. The computer 10 generates print data of a colorimetric sheet including a color chart and causes the printer 20 to print the print data.

In the present embodiment, the colorimetric sheet is used to create adjusted color data. The adjusted color data is profile data for performing printing with an intended color in the printer 20. For example, the adjusted color data includes an LUT or the like in which colors (for example, CIELAB values) in an apparatus-independent color space are associated with gradation values of colors of color materials used by the printer 20.

A user measures the color of each patch included in the color chart on the colorimetric sheet using the colorimeter 30. The computer 10 acquires the result of color measurement using the colorimeter 30 and creates the adjusted color data by associating the gradation value of each color of the color material used when printing each patch with the colorimetric value such as a CIELAB value. The system according to the present embodiment has a function of adjusting a color chart included in a colorimetric sheet based on a size of a medium designated by the user and the like and realizing efficient color measurement and color measurement with high operability.

### (1-1) Configuration of Computer:

FIG. 2 is a block diagram illustrating a configuration of the computer 10. In the present embodiment, the computer 10 includes a processor 10a, a communication unit 10b, a nonvolatile memory 10c, a display unit 10d, and an input unit 10e. The processor 10a includes a CPU, a ROM, a RAM, and the like which are not illustrated, and can execute various programs recorded in the nonvolatile memory 10c to control each unit of the computer 10, the printer 20, and the colorimeter 30.

The processor 10a may be configured by a single chip, may be configured by a plurality of chips, or may be configured as an SoC together with various functional blocks. Further, for example, an ASIC may be employed instead of the CPU, or the CPU and the ASIC may cooperate with each other. In a case where each apparatus in the present embodiment includes a processor, the processor may be realized in various aspects similarly to the processor 10a.

The communication unit 10b includes a communication interface for communicating with an external device according to various communication protocols. The computer 10 can communicate with other apparatuses (the printer 20 and the colorimeter 30) via the communication unit 10b. The communication unit 10b may include an interface for communicating with various removable memories attached to the computer 10.

The display unit 10d is a display device configured to display any image. The input unit 10e is a device on which a user performs an input operation. The computer 10 can be realized in various modes, and may be a stationary computer or a portable computer. In the former case, the display unit 10d can be configured by, for example, a display independent of the main body of the computer, and the input unit 10e can be configured by, for example, a keyboard, a mouse, or the like independent of the main body of the computer. In the latter case, the display unit 10d and the input unit 10e can be configured by, for example, a touch panel display integrated with the main body of the computer or the like. In any case, the user can input the user's intention by operating the input unit 10e while visually recognizing an image or a character displayed on the display unit 10d.

The processor 10a can execute a colorimetric sheet production program and a printer production program (not illustrated). By executing the colorimetric sheet production program, the processor 10a determines the size or the like of the color chart in accordance with the size or the like of the medium designated by the user, and generates colorimetric sheet data 10c1 for printing the colorimetric sheet. The processor 10a transmits the colorimetric sheet data 10c1 to the printer 20 and causes the printer 20 to print the colorimetric sheet.

When the colorimetric sheet is printed, the user measures the color of each patch using the colorimeter 30. By executing the printer production program, the processor 10a acquires colorimetric data 10c2 indicating the result of color measurement performed by the user. Then, the processor 10a creates adjusted color data 10c3 based on the colorimetric data 10c2. Details of these processes are described below.

### (1-2) Configuration of Printer:

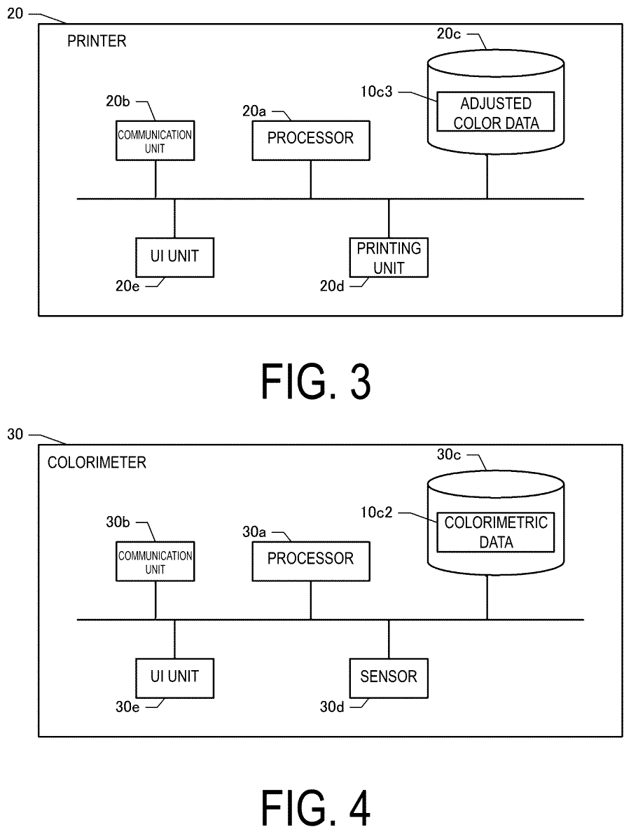

FIG. 3 is a block diagram illustrating a configuration of the printer 20. The printer 20 includes a processor 20a, a communication unit 20b, a nonvolatile memory 20c, a printing unit 20d, and a UI unit 20e. The processor 20a includes a CPU, a ROM, a RAM, and the like, which are not illustrated, and can control each unit of the printer 20 by executing a control program recorded in the nonvolatile memory 20c.

The communication unit 20b includes a communication interface for communicating with the computer 10 in accordance with various wired or wireless communication protocols. The printer 20 can communicate with the computer 10 via the communication unit 20b. The communication unit 20b may include an interface for communicating with various removable memories attached to the printer 20.

The printing unit 20d includes an actuator, various devices, a sensor, a driving circuit, a mechanical component, and the like for executing printing on a medium. The sensor includes a sensor that detects various detection targets that is variable in the printer 20. Examples include a sensor that detects the medium remaining amount, a sensor that detects the remaining amount of a color material for each color used in printing, and the like. In the present embodiment, the printing unit 20d includes a mechanism that performs recording on a medium using color materials of predetermined colors (such as, for example, cyan, magenta, yellow, and black), and prints various images through the recording on the medium using the color materials in amounts indicated by the print data.

In addition, the printing unit 20d can perform printing on media of various sizes. While the printing unit 20d of the present embodiment can perform printing on at least three types of media of the first size, the second size, and the third size, in the present embodiment, a mode in which printing can be performed on media of wider variety of sizes is assumed. The size of the medium, which can be selected to be any size, can be selected from a plurality of predetermined sizes (for example, A3, B5, and the like) in the present embodiment. Specifically, the printing unit 20d includes an accumulation unit for accumulating media of various sizes, and is capable of conveying and performing printing on the accumulated media.

The UI unit 20e includes an input unit such as a button or a touch panel provided on a housing of the printer 20 and a display unit that displays various types of information. The user can issue various instructions by operating the input unit based on the information displayed on the display unit of the UI unit 20e.

In the present embodiment, the adjusted color data 10c3 created by the computer 10 is transferred to the printer 20 and stored in the nonvolatile memory 20c. Thus, in the present embodiment, the processor 20a refers to the adjusted color data 10c3 in the process of converting the color such as RGB indicated by the print data of the print target into the amount of the color material through color conversion. Of course, the color conversion with reference to the adjusted color data 10c3 may be performed in the computer 10.

### (1-3) Configuration of Colorimeter:

FIG. 4 is a block diagram illustrating a configuration of the colorimeter 30. The colorimeter 30 includes a processor 30a, a communication unit 30b, a nonvolatile memory 30c, a sensor 30d, and a UI unit 30e. The processor 30a includes a CPU, a ROM, a RAM, and the like, which are not illustrated, and can control each unit of the colorimeter 30 by executing a control program recorded in the nonvolatile memory 30c.

The communication unit 30b includes a communication interface for communicating with the computer 10 in accordance with various wired or wireless communication protocols. The colorimeter 30 can communicate with the computer 10 via the communication unit 30b. The sensor 30d is a device that irradiates a color measurement target with light having a predetermined color temperature and detects a spectral distribution of reflection light. The processor 30a acquires a colorimetric value (for example, a CIELAB value) indicating the color of the color measurement target based on a color in the apparatus-independent color space, based on the result of reading by the sensor 30d.

The colorimetric value indicating the acquired color measurement result is associated with identification information of the patch, and stored in the nonvolatile memory 30c as the colorimetric data 10c2. In the present embodiment, the arrangement order of the patches arranged in the color chart of the colorimetric sheet is a predetermined order. The order in which the color measurement is performed on the patches by the colorimeter 30 is determined to match the arrangement order. Thus, the user performs the color measurement using the colorimeter 30 according to the arrangement order. Assuming that the color measurement has been performed according to the arrangement order, the processor 30a associates the identification information with the colorimetric value of each patch to obtain the colorimetric data 10c2.

The UI unit 30e is a button or the like provided on a housing of the colorimeter 30. By operating the UI unit 30e, the user can issue an instruction such as that for starting the color measurement for each patch and the like. The processor 30a receives an instruction from the user based on output information from the UI unit 30e.

In the present embodiment, the user can select and use any model from a plurality of models of the colorimeter 30. Specifically, there are automatic colorimeter models with which movement and the like of the colorimeter 30 are automatically performed, and manual colorimeter models with which the movement and the like of the colorimeter 30 are manually performed. In addition, a colorimetry jig for assisting measurement with the manual colorimeter model may be used. That is, in a case where the user owns a colorimetry jig that assists color measurement using the colorimeter 30, the color measurement can be manually performed using the colorimetry jig.

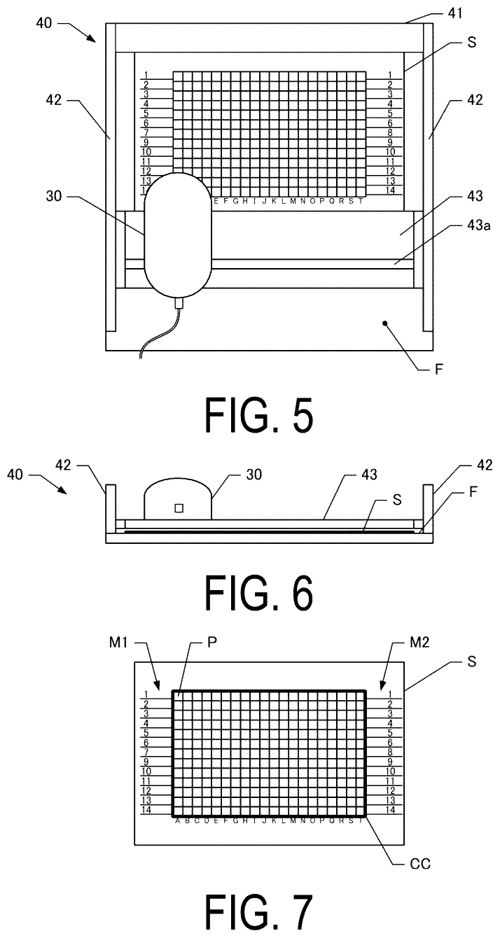

FIG. 5 and FIG. 6 are diagrams illustrating how the manual color measurement is performed using the colorimetry jig. FIG. 5 illustrates a colorimetry jig 40 as viewed in a direction perpendicular to a placement surface F where a colorimetric sheet S is placed on the colorimetry jig 40. FIG. 6 illustrates the colorimetry jig 40 as viewed in a direction parallel to the placement surface F from the lower side in FIG. 5.

In the present embodiment, the colorimetry jig 40 has a structure in which the colorimetric sheet S is placed on the placement surface F of a rectangular shape. One of the four sides of the placement surface is provided with a clip 41 for holding the colorimetric sheet S. Stoppers 42 for limiting the movement range of the colorimeter 30 are provided on two sides adjacent to the side on which the clip 41 is formed. In the present embodiment, the stoppers 42 are rectangular members that extend along the two sides of the placement surface F, limit the movement of the colorimeter 30, and come into contact with end portions of the colorimeter 30 in the width direction (the left-right direction in FIG. 5 and FIG. 6), to prevent the colorimeter 30 from protruding beyond the placement surface F.

A guide portion 43 is provided between the stoppers 42. The guide portion 43 is a member extending from one stopper 42 to the other stopper 42 between the stoppers 42. In the guide portion 43, a groove 43a is formed in a direction parallel to the side of the placement surface F on which the clip 41 is formed. A protrusion portion (not illustrated) is formed on the colorimeter 30, and the colorimeter 30 can move in the longitudinal direction of the groove 43a with the protrusion portion fitted in the groove 43a. Specifically, when continuously measuring the colors of the patches P arranged in the longitudinal direction of the groove 43a, the user can move the colorimeter 30 along a straight line by moving the colorimeter 30 in the longitudinal direction of the groove 43a with the protrusion portion of the colorimeter 30 fitted in the groove 43a. Here, the longitudinal direction of the groove 43a is referred to as a first direction. The guide portion 43 can be slid in the longitudinal direction of the stopper 42. Therefore, after the colorimeter 30 is moved in the first direction (row direction) to measure the color from end to end of the color chart, the guide portion 43 is moved in a direction (column direction) orthogonal to the first direction. Then, the operation of moving the colorimeter 30 in the first direction (row direction) and measuring the color from end to end of the color chart is performed again.

FIG. 7 is a view illustrating the colorimetric sheet S extracted. In the present embodiment, the colorimetric sheet S is a rectangular sheet, and a color chart CC including the plurality of patches P is printed on one surface of the colorimetric sheet S. The plurality of patches P are arranged in a direction parallel to one side of the rectangular colorimetric sheet S, and the patches P are also arranged in a direction orthogonal to the direction. When the number of patches P printed on one sheet is less than a predetermined number, a plurality of the colorimetric sheets S are printed.

In the example illustrated in FIG. 7, the lateral direction (row direction) corresponds to the first direction. In FIG. 7, it is assumed that the color measurement starts from the patch P printed at the uppermost position in the column direction and at the leftmost position in the row direction, the colorimeter 30 is moved to the right along the first direction, and when the color measurement is performed up to the right end of one row, the color measurement for the one row ends. When the color measurement for one row ends, the color measurement is performed on the patches on the unmeasured row which is adjacent in the column direction. When the color measurement is performed on the patches of the unmeasured row, the color measurement starts from the patch printed at the rightmost position in the row direction, the colorimeter 30 is moved to the left along the first direction, and the color measurement for one row ends when the color measurement is performed up to the left end of the one row. Through repetition of the above operation, the user measures the colors of the patches in the arrangement order. That is, the user moves the colorimeter 30 from left to right in the odd-numbered rows, and moves the colorimeter 30 from right to left in the even-numbered rows.

On the colorimetric sheet S illustrated in FIG. 7, marks for preventing mistake in the order of color measurement are printed together with the color chart CC. Specifically, the colorimetric sheet S includes a first mark M1 indicating a start position of color measurement using the colorimeter 30 at one end portion in the first direction and a second mark M2 indicating a start position of the color measurement using the colorimeter 30 at the other end portion in the first direction.

Each of the first mark M1 and the second mark M2 includes a straight line extending in the first direction, i.e., the row direction, and a numerical value indicating the row number. The intersection of the straight line and the patch is the path color measurement start position. For example, the first mark M1 which is composed of a numerical value 1 and a straight line and is written at the top indicates the first row to be subjected to the color measurement using the colorimeter 30. The second mark M2 which is composed of a numerical value 2 and a straight line and is written at second from the top indicates the second row to be subjected to the color measurement using the colorimeter 30. FIG. 7 illustrates an example in which the first mark M1 and the second mark M2 indicating the order in which the rows are subjected to the color measurement are provided up to the 14th row. In the present embodiment, characters A to T, which are marks indicating columns of patches, are also illustrated in association with the respective columns of patches.

The number of patches (the number of patches in one row) in the first direction in the color chart CC may vary depending on the size of the medium, designation by the user, or the like, but the size of the patch is the same regardless of the size of the medium, designation by the user, or the like. Specifically, the size of the patch is fixed to a predetermined size equal to or larger than the minimum size measurable by the colorimeter 30. For this reason, even when conditions such as the size of the medium and designation by the user vary, the color measurement can be easily performed on the patches using the colorimeter 30.

### (2) Method for Producing Colorimetric Sheet

If the number of patches in the first direction in the color chart CC is fixed, a large medium would have a large margin, and the number of media excessively increases, or measurement of a large number of rows is required, resulting in compromised work efficiency. Further, not all users use the colorimetry jig 40. In a case where the colorimetry jig 40 is not used, a user who is accustomed to the color measurement using the colorimeter 30 tends to give priority to work efficiency of the color measurement, and a user who is not accustomed to the color measurement tends to give priority to ease of work, meaning that there may be various needs.

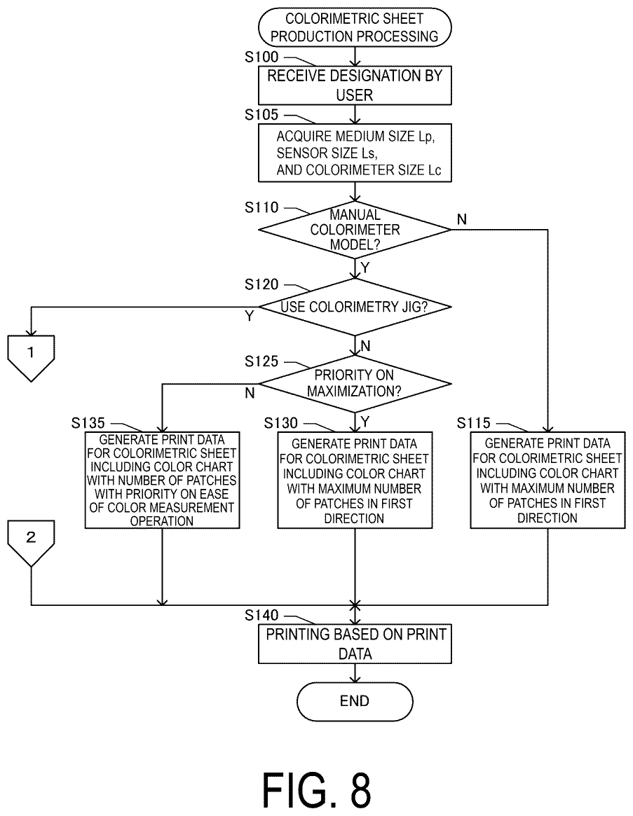

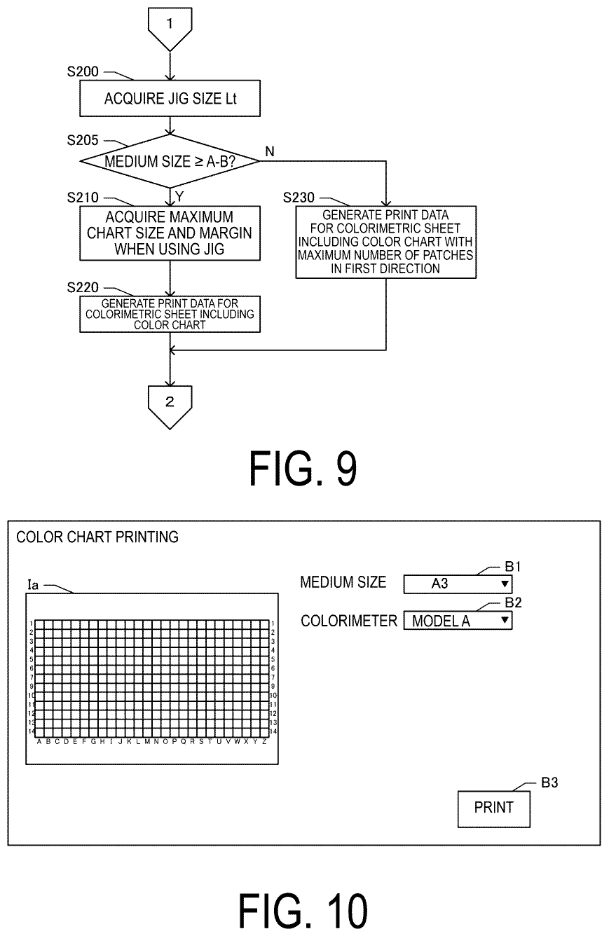

Therefore, in the present embodiment, the processor 10a produces the colorimetric sheet S by changing the size of the color chart CC according to various needs. FIG. 8 and FIG. 9 are flowcharts illustrating colorimetric sheet production processing. The colorimetric sheet production processing starts in response to a predetermined execution start trigger, example of which including input of an execution instruction by the user operating the input unit of the computer 10.

When the colorimetric sheet production processing starts, the processor 10a receives designation by the user (step S100). Specifically, the processor 10a receives designation of the size of the medium and the model of the colorimeter 30. Further, when there is an item to be designated depending on the model of the colorimeter 30, the processor 10a also receives designation of the item.

In order to receive designation for each item, the processor 10a controls the display unit 10d to display a user interface for receiving the designation. FIG. 10 is a diagram illustrating an example of the user interface. In the user interface, a medium size selection section B1 and a model selection section B2 for the colorimeter 30 are provided on the right side of the screen.

In the medium size selection section B1, the user can designate a medium size from among a plurality of sizes including a first size, a second size, and a third size. When the user selects the selection section B1 using the input unit 10e, the processor 10a controls the display unit 10d to display the sizes of the selectable media. The first size, the second size, and the third size may be various sizes, with the first being the largest, the second size being the second largest, and the third size being the smallest. When the user designates a medium using the input unit 10e, the processor 10a regards that as an instruction to print the color chart CC on the medium of the designated size to produce the colorimetric sheet S.

In the model selection section B2 for the colorimeter 30, the user can designate the model of the colorimeter 30. When the user selects the selection section B2 using the input unit 10e, the processor 10a controls the display unit 10d to display the selectable models of the colorimeter 30. The models include the automatic colorimeter model and the manual colorimeter model. When the user designates the model of the colorimeter 30 using the input unit 10e, the processor 10a regards it as an instruction to produce the colorimetric sheet S using the colorimeter 30 of the designated model.

When the manual colorimeter model is designated in the selection section B2, the processor 10a further controls the display unit 10d to display an interface for inputting an additional item. When the automatic colorimeter model is designated in the selection section B2, no additional item is displayed. On the other hand, the processor 10a displays an icon showing an overview of the colorimetric sheet S on the left side of the user interface. In FIG. 10, an icon Ia of the colorimetric sheet S with the maximum number of patches in one row, is shown on the left side of the user interface. Thus, FIG. 10 is a user interface displayed when the automatic colorimeter model is selected. When the automatic colorimeter model is used, even a user who is not accustomed to the color measurement can easily perform the color measurement. Thus, as indicated by the icon Ia, the colorimetric sheet S with the maximum number of patches in one row is printed, and color measurement can be performed with high efficiency. Image data of the icon displayed on the left side of the user interface is created in advance, and the processor 10a switches the icon in accordance with the contents selected in the selection sections B1 and B2. Since the number of patches is calculated in processing to be described below, the number of patches indicated by the icon is not accurate. Still, the user can recognize the overview of the colorimetric sheet S by the size of the margin indicated by the icon and the like.

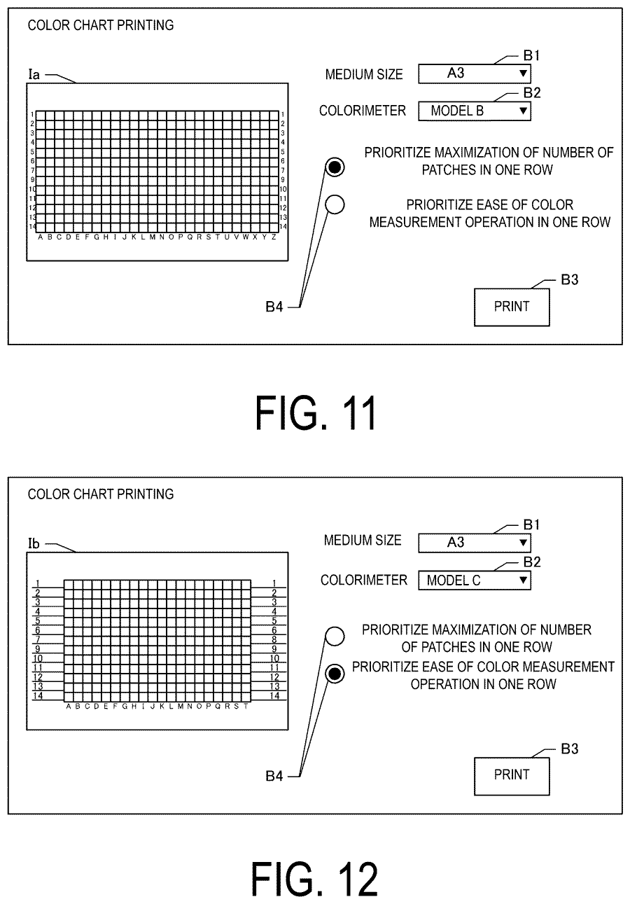

FIG. 11 to FIG. 13 are diagrams illustrating examples of user interfaces displayed when the manual colorimeter model is designated in the selection section B2. In the user interfaces illustrated in FIG. 11 to FIG. 13, the selection sections B1 and B2 are the same as those in the user interface illustrated in FIG. 10. The manual colorimeter model includes the colorimeter 30 with which the colorimetry jig 40 is not used and the colorimeter 30 with which color measurement can be performed using the colorimetry jig 40.

When the model of the colorimeter 30 selected by the user in the selection section B2 is a model with which the colorimetry jig 40 is not used, the processor 10a controls the display unit 10d to display radio buttons B4 for the user to select a prioritized matter (see FIGS. 11 and 12). Each of the radio buttons B4 is associated with a character string indicating the content of instruction issued using the radio button B4. In the example illustrated in FIG. 11, the user can select one desired option from options of “give priority to maximization of number of patches in one row” and “give priority to ease of color measurement operation in one row”. Note that the options are not limited to these, and for example, an option for designating a margin size desired by the user and the like may be provided.

FIG. 11 is a diagram illustrating a state in which the user has designated the option “give priority to maximization of number of patches in one row” using the radio button B4. In this case, the number of patches in one row is maximized and the margin in the row direction is minimized. Thus, the icon Ia similar to that in FIG. 10 is displayed on the left side of the user interface.

FIG. 12 is a diagram illustrating a state in which the user has designated the option “give priority to ease of color measurement operation in one row” using the radio button B4. In this case, a margin in the row direction is provided so that the movement of the colorimeter 30 is not hindered by a step formed by the thickness of the medium of the colorimetric sheet S. As a result, the margin in the row direction is larger than that in the case where the number of patches in one row is maximized. It can be recognized that an icon Ib illustrated on the left side of the user interface has a larger margin than the icon Ia illustrated in FIG. 10 and FIG. 11.

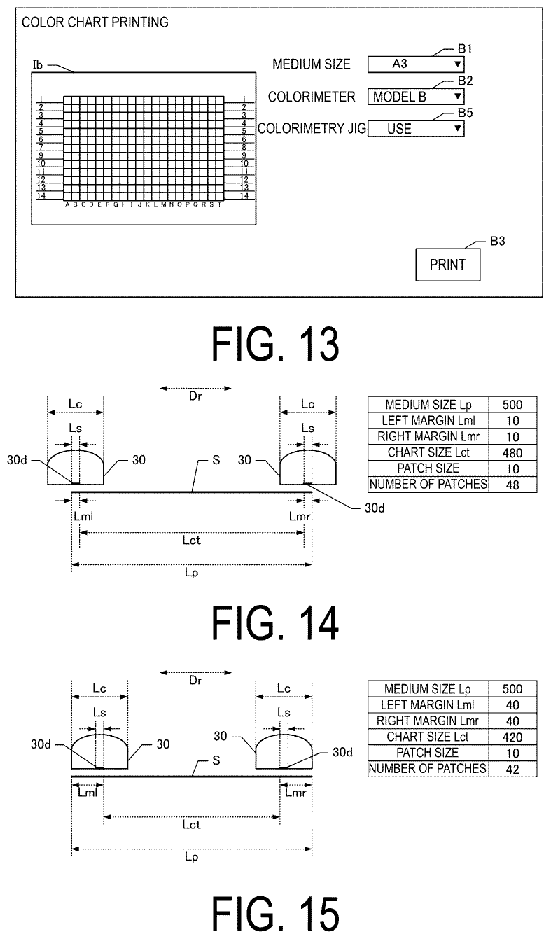

When the model of the colorimeter 30 selected by the user in the selection section B2 is a model with which the color measurement can be performed using the colorimetry jig 40, the processor 10a controls the display unit 10d to display a selection section B5 for the user to select whether or not to use the colorimetry jig 40 (see FIG. 13). In the selection section B5 for selecting whether or not to use the colorimetry jig 40, the user can designate whether or not to use the colorimetry jig 40. When the user selects the selection section B5 using the input unit 10e, the processor 10a controls the display unit 10d to display “used” or “not used” for the colorimetry jig. When the user designates “use” for the colorimetry jig using the input unit 10e, the processor 10a regards that the colorimetry jig 40 is to be used. FIG. 13 illustrates a user interface in a case where “use” is thus selected. Also in this case, the number of patches in one row is not maximized. Thus, it can be recognized that the icon Ib illustrated on the left side of the user interface is an icon similar to that in FIG. 12, and has a larger margin than the icon Ia illustrated in FIG. 10 and FIG. 11. When the user designates “not used” for the colorimetry jig using the input unit 10e, the processor 10a regards that the colorimetry jig 40 is not to be used. In this case, as in FIG. 11 and FIG. 12, the processor 10a causes the user interface to display options selectable with the radio buttons B4.

The user performs designation using the user interface as illustrated in FIG. 10 to FIG. 13. At the lower right of the user interface, a print instruction button B3 is provided. When the user issues a print instruction by the print instruction button B3 using the input unit 10e after making various designations using the user interface, the processor 10a performs the processing in step S105 and subsequent steps.

In step S105, the processor 10a acquires a medium size Lp, a sensor size Ls, and a colorimeter size Lc. Specifically, the processor 10a acquires the medium size Lp in the first direction associated with the medium designated by the user in step S100. Further, the processor 10a acquires the sensor size Ls and the colorimeter size Lc in the first direction associated with the model of the colorimeter designated by the user in step S100.

Next, in step S110, the processor 10a determines whether or not the model designated by the user is a manual colorimeter model. In step S110, when it is not determined that the model designated by the user is the manual colorimeter model, that is, when the automatic colorimeter model is designated, the processor 10a generates print data of the colorimetric sheet including the color chart with the maximum number of patches in the first direction (row direction) (step S115).

When the automatic colorimeter model is used, the color measurement can be easily performed even if a user is not accustomed to the color measurement. For this reason, in the present embodiment, the colorimetric sheet S is produced so that the color measurement can be performed most efficiently. In other words, the number of patches in the row direction is maximized. Specifically, the processor 10a regards a length obtained by subtracting a minimum margin size provided at both ends from the medium size Lp in the first direction as the range of the color chart CC in the first direction.

Then, the processor 10a identifies the number of patches for arranging patches of a predetermined size without gaps within the range to maximize the number of patches in the row direction. Further, the processor 10a generates image data for printing with the patches arranged in such a number of patches in the row direction, the patches arranged in order from the left in the arrangement order in odd-numbered rows, and the patches arranged in order from the right in the arrangement order in even-numbered rows. Further, the processor 10a generates image data for printing a numerical value indicating a row and a character indicating a column in a margin portion, and generates print data by combining these pieces of image data.

When the print data is generated, the processor 10a performs printing based on the print data (step S140). Specifically, the processor 10a transmits the print data to the printer 20 and causes the printer 20 to print the colorimetric sheet S. As a result, the colorimetric sheet S in which the number of patches in the row direction is maximized is printed as indicated by the icon Ia shown in the user interface in FIG. 10. Since the user can perform color measurement with the automatic colorimeter model using the colorimetric sheet S, the color measurement operation can be performed with the number of color measurement patches maximized for each row, and thus can be efficiently performed.

On the other hand, when it is determined in step S110 that the model designated by the user is the manual colorimeter model, the processor 10a determines whether or not the colorimetry jig 40 is designated to be used (step S120). When it is determined in step S120 that the colorimetry jig 40 is designated to be used, the processor 10a executes the processing illustrated in FIG. 9. The processing illustrated in FIG. 9 will be described below.

In step S120, when it is not determined that the colorimetry jig 40 is designated to be used, the processor 10a determines whether or not the user has designated, using the radio button B4, to give priority to the maximization of the number of patches in one row (step S125). In step S125, when it is determined that the user has designated to give priority to the maximization of the number of patches in one row, the processor 10a generates print data for a colorimetric sheet including a color chart with the maximum number of patches in the first direction (row direction) (step S130). FIG. 14 is a diagram for explaining the colorimetric sheet S with the maximum number of patches in the first direction. FIG. 14, with the colorimetric sheet S illustrated on the left side of the drawing, schematically illustrates a state in which the colorimeter 30 is disposed at the left and right color measurement start positions in a first direction Dr.

The sensor 30d included in the colorimeter 30 has the sensor size Ls in the first direction Dr, and can measure the color of a patch having the same width as the sensor size Ls. In the present embodiment, a patch is not present at the color measurement start position, and the color measurement starts from a margin of the medium (however, the margin can include a character). Therefore, the color measurement can be efficiently performed in the first direction Dr by starting the color measurement from a state in which one end portion of the sensor 30d is aligned with one end portion of the medium in the first direction Dr and with the patch appearing as soon as the colorimeter 30 moves toward the other end portion. Also at the other end portion, if the same arrangement is adopted, the number of patches in the first direction Dr can be maximized.

Therefore, in the present embodiment, the processor 10a acquires a chart size Lct in the first direction by subtracting the sensor size Ls×2 of the sensor 30d, which is the minimum margin size at both ends, from the medium size Lp in the first direction Dr. Then, the processor 10a acquires the number of patches in the first direction by dividing the chart size Lct by the patch size in the first direction.

In FIG. 14, an example size is illustrated on the right side. In this example, the medium size Lp is 500 mm. Further, since the sensor size Ls is 10 mm, both a left margin Lml and a right margin Lmr are 10 mm. As a result, the chart size Lct is calculated by 500−10×2 and thus is 480 mm. Since the sensor size Ls is 10 mm and the patch size is 10 mm, the number of patches is 48 (=480/10).

When the number of patches in the first direction is acquired, the processor 10a generates image data for printing with the patches arranged in the arrangement order from the left in the odd-numbered rows and arranged in the arrangement order from the right in the even-numbered rows. The color chart generated as described above is a first pattern in which color measurement starts with the colorimeter 30 protruding beyond the medium in the first direction. According to the first pattern, it is possible to maximize the number of patches arranged in the first direction and to efficiently perform the color measurement operation.

Further, the processor 10a generates print data of the colorimetric sheet S including the color chart. Specifically, the processor 10a generates image data indicating a character to be printed in the margin portion, and combines the image data with the image data of the color chart. Then, the processor 10a generates print data for printing the combined image data. When the print data is generated, the processor 10a transmits the print data to the printer 20 and causes the printer 20 to print the colorimetric sheet S (step S140). As a result, the colorimetric sheet S in which the number of patches in the row direction is maximized is printed as indicated by the icon Ia shown in the user interface in FIG. 11. Since the user can perform color measurement using the colorimetric sheet S, the color measurement operation can be performed with the number of color measurement patches maximized for each row, and thus can be efficiently performed.

On the other hand, in step S125, when it is not determined that the user has designated to give priority to the maximization of the number of patches in one row, the processor 10a generates print data of a colorimetric sheet including a color chart with the number of patches set to prioritize the ease of the color measurement operation (step S135). FIG. 15 is a diagram for explaining the colorimetric sheet S with priority on ease of color measurement operation. FIG. 15, with the colorimetric sheet S illustrated on the left side of the drawing, schematically illustrates a state in which the colorimeter 30 is disposed at the left and right color measurement start positions in a first direction Dr.

The sensor 30d included in the colorimeter 30 has the sensor size Ls in the first direction Dr, and can measure the color of a patch having the same width as the sensor size Ls. In the present embodiment, a patch is not present at the color measurement start position, and the color measurement starts from a margin of the medium (however, the margin can include a character). When the colorimeter 30 protrudes beyond the medium in the first direction at the start position of the color measurement start position, the operation requires a special attention due to the colorimeter 30 being inclined by a step generated between the surface on which the colorimetric sheet S is placed and the surface of the colorimetric sheet S, or the colorimeter 30 being caught by the step. However, when a margin is provided so that the colorimeter 30 does not protrude beyond the medium in the first direction, the colorimeter 30 is not affected by the step when the colorimeter 30 is set at the start position.

Therefore, when the ease of the color measurement operation is prioritized, the color measurement starts from a state in which one end portion of the colorimeter 30 is aligned with one end portion of the medium in the first direction Dr, and with the patch immediately appearing when the colorimeter 30 moves from this position toward the other end portion. For example, at the left end in the first direction, as illustrated in FIG. 15, the left margin Lml is the length from the left side end portion of the colorimeter 30 to the right end portion of the sensor 30d. The same arrangement is adopted in the other end portion, and the right margin Lmr is the length from the right end portion of the colorimeter 30 to the left end portion of the sensor 30d.

Therefore, the processor 10a calculates the size of the left margin Lml by adding the sensor size Ls in the first direction to (the size Lc of the colorimeter 30 in the first direction−the sensor size Ls in the first direction)/2. Similarly, the processor 10a calculates the size of the right margin Lmr by adding the sensor size Ls in the first direction to (the size Lc of the colorimeter 30 in the first direction−the sensor size Ls in the first direction)/2.

Further, the processor 10a acquires the chart size Lct in the first direction by subtracting the left margin Lml and the right margin Lmr from the medium size Lp in the first direction Dr. Then, the processor 10a acquires the number of patches in the first direction by dividing the chart size Lct by the patch size in the first direction.

In FIG. 15, an example size is illustrated on the right side. In this example, the medium size Lp is 500 mm. Further, since the size Lc of the colorimeter 30 is 70 mm and the sensor size Ls is 10 mm, both the left margin Lml and the right margin Lmr are 40 mm (=10+(70−10)/2). As a result, the chart size Lct is 420 mm (=500−40×2). Since the sensor size Ls is 10 mm and the patch size is 10 mm, the number of patches is 42 (=420/10).

When the number of patches in the first direction is acquired, the processor 10a generates image data for printing with the patches arranged in the arrangement order from the left in the odd-numbered rows and arranged in the arrangement order from the right in the even-numbered rows. The color chart generated as described above is a second pattern in which color measurement can start without the colorimeter 30 protruding beyond the medium in the first direction. With the second pattern, the user can set the colorimeter 30 at the start position without being affected by the step formed by the medium, and even a user who is not accustomed to the color measurement can easily perform the color measurement operation.

Further, the processor 10a generates print data of the colorimetric sheet S including the color chart. Specifically, the processor 10a generates image data indicating a mark such as a character to be printed in the margin portion, and combines the image data with the image data of the color chart. Then, the processor 10a generates print data for printing the combined image data. When the ease of the color measurement operation is prioritized, the marks printed in the left and right margins are the first mark and the second mark illustrated in FIG. 7.

When the print data is generated, the processor 10a transmits the print data to the printer 20 and causes the printer 20 to print the colorimetric sheet S (step S140). As a result, as indicated by the icon Ib shown in the user interface of FIG. 12, the colorimetric sheet S can be printed enabling the colorimeter to be set at the start position without being affected by the step. Since the user can start the color measurement using the colorimetric sheet S without the need for taking the step into consideration, even an unaccustomed user can easily perform the color measurement operation.

On the other hand, when it is determined in step S120 that the colorimetry jig 40 is designated to be used, the processor 10a generates a color chart using the relationship between the colorimetry jig 40 and the medium through the processing illustrated in FIG. 9. Specifically, the processor 10a acquires a jig size Lt (step S200). To be specific, the processor 10a acquires the jig size Lt in the first direction associated with the model of the colorimetry jig 40 designated by the user in step S100.

Next, the processor 10a determines whether or not the medium size is equal to or greater than A-B (step S205). Here, A is the size of the colorimetry jig 40 determined according to the model of the colorimetry jig 40, that is, the jig size Lt. B is a value corresponding to the size of the colorimeter 30, which is determined according to the model of the colorimeter 30. In the present embodiment, B is the size of a dead space in which color measurement cannot be performed due to the use of the colorimetry jig 40. In the present embodiment, the size of the dead space is the colorimeter size Lc−the sensor size Ls.

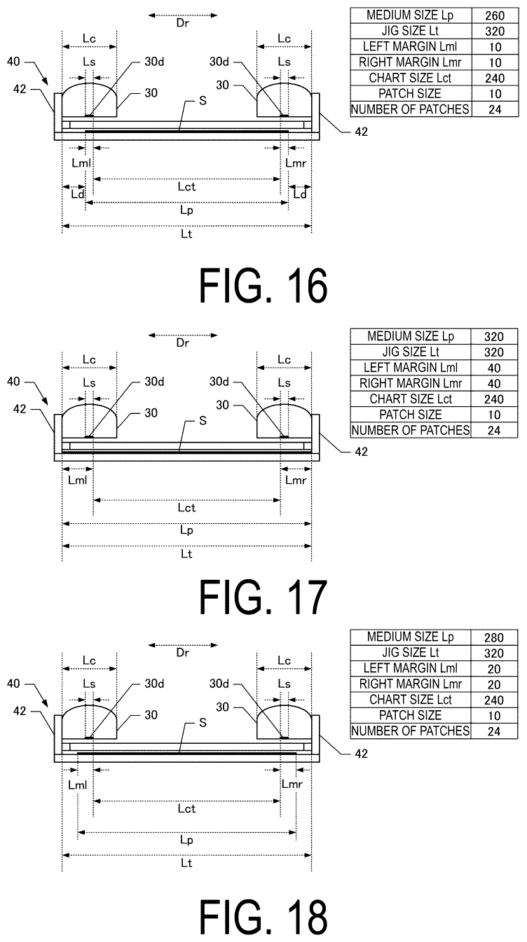

FIG. 16 schematically illustrates a state in which the colorimeter 30 is disposed at the left end in the first direction with the colorimeter 30 abutted against the stopper 42 on the left side in the first direction and a state in which the colorimeter 30 is disposed at the right end in the first direction with the colorimeter 30 abutted against the stopper 42 on the right side in the first direction in the case of using the colorimetry jig 40. When the colorimetry jig 40 is used, the colorimeter 30 cannot be disposed on the left side beyond the left stopper 42, and the colorimeter 30 cannot be disposed on the right side beyond the right stopper 42. Therefore, the size in which the measurement can be performed in the first direction when the color measurement starts from the position of the colorimeter 30 at one end portion (for example, the left end portion) illustrated in FIG. 16 and ends at the position of the colorimeter 30 at the other end portion (for example, the right end portion) is the maximum measurable size in the first direction.

The value B corresponding to the colorimeter 30 is a value used for identifying the maximum size. That is, when the colorimeter 30 is brought into contact with the stopper 42, a distance Ld from the end portion at which the stopper 42 and the colorimeter 30 are brought into contact with each other to the end portion of the sensor 30d on the stopper 42 side is the dead space in which color measurement cannot be performed, and the dead spaces in which color measurement cannot be performed exist at both ends in the first direction. Therefore, in the present embodiment, the value B is the distance Ld×2 between the stopper 42 and the sensor 30d in the case where the colorimeter 30 is in contact with the stopper 42. Thus, the processor 10a acquires the value B as (sensor size Ls+(colorimeter size Lc−sensor size Ls)/2)×2.

When the value A and the value B are defined as described above, A-B matches the size of the color measurement that starts from one end portion in the first direction and ends at the other end portion. Even when the medium size Lp is larger than the above size, the dead space does not change, and thus the size in which the color measurement can be performed does not change. For this reason, even if the medium size Lp exceeds A-B, the size of the color chart CC on the medium does not become large, and the margin becomes large. On the other hand, when the medium size Lp is equal to or less than A-B, the size of the color chart CC may vary depending on the medium size Lp. Thus, A-B can be used as the threshold value.

In the present embodiment, in order to branch the processing using the threshold value, the processor 10a determines whether or not the medium size Lp is equal to or greater than A-B in step S205. In a case where it is determined in step S205 that the medium size Lp is equal to or greater than A-B, the processor 10a acquires the maximum chart size and margin in a case where the jig is used (step S210). Specifically, as illustrated in FIG. 16, in a case where the colorimetry jig 40 is used, when color measurement starts and ends with the colorimeter 30 abutted against the left and right stoppers 42 in the first direction, the color measurement range in the first direction is maximized. Therefore, the processor 10a acquires the maximum chart size Lct in the case of using the jig as the jig size Lt−the dead space distance Ld×2−the sensor size Ls×2. When the medium size Lp is equal to or greater than A-B, the chart size Lct is a fixed value regardless of the size of the medium.

Further, the processor 10a acquires the margin size by subtracting the chart size Lct from the medium size Lp. In the present embodiment, the color measurement is assumed to be performed with the medium placed at the center of the colorimetry jig 40 in the first direction. Therefore, the processor 10a acquires the left margin Lml and the right margin Lmr by dividing the margin size by 2.

Next, the processor 10a generates print data of the colorimetric sheet S including the color chart (step S220). Specifically, the processor 10a acquires the number of patches in the first direction by dividing the chart size Lct by the patch size in the first direction. When the number of patches in the first direction is acquired, the processor 10a generates image data for printing with the patches arranged in the arrangement order from the left in the odd-numbered rows and arranged in the arrangement order from the right in the even-numbered rows.

FIG. 16 illustrates an example in which the medium size Lp is equal to A-B, and FIG. 17 and FIG. 18 illustrate examples in which the medium size Lp is greater than A-B. The medium size Lp illustrated in FIG. 17 is larger than the medium size Lp illustrated in FIG. 18. Therefore, the medium size Lp illustrated in FIG. 17 is the first size, and the medium size Lp illustrated in FIG. 18 is the second size.

In FIG. 16 to FIG. 18, an example size is illustrated on the right side. In these examples, the size Lc of the colorimeter 30 is 70 mm, the sensor size Ls is 10 mm, and the distance Ld of the dead space is 30 mm. Since the jig size Lt is 320 mm, the chart size Lct is 240 mm (=320−30×2−10×2).

In the examples of FIG. 16 to FIG. 18, since the chart size Lct does not change, the margin size is the medium size Lp−the chart size Lct. Since the size of the margin is equally divided into the left and right, in the example of FIG. 16, the size of the margin is 10 mm (=(260−240)/2). Similarly, in the example of FIG. 17, the size of the margin is 40 mm (=(320−240)/2), and in the example of FIG. 18, the size of the margin is 20 mm (=(280−240)/2).

In addition, in the examples of FIG. 16 to FIG. 18, since the chart size Lct does not change, the number of patches is 24 (=240/10) in all cases. Therefore, printed is a color chart in which the number of patches arranged in the first direction is the same regardless of whether the size of the medium in the first direction is the first size or the second size greater than A-B.

When the number of patches in the first direction is acquired, the processor 10a generates image data for printing with the patches arranged in the arrangement order from the left in the odd-numbered rows and arranged in the arrangement order from the right in the even-numbered rows. The color chart generated as described above is a first pattern in which color measurement starts with the colorimeter 30 protruding beyond the medium in the first direction (except for the case where the medium size Lp=the jig size Lt holds). With the first pattern, the largest possible number of patches can be arranged in the first direction. When the colorimetry jig 40 is used, even the user who is not accustomed to the color measurement can easily perform the color measurement. Therefore, when the largest possible patches are arranged in the first direction with the first pattern, the color measurement operation can be efficiently performed.

Further, the processor 10a generates print data of the colorimetric sheet S including the color chart. Specifically, the processor 10a generates image data indicating a mark such as a character to be printed in the margin portion, and combines the image data with the image data of the color chart. Then, the processor 10a generates print data for printing the combined image data. When the colorimetry jig 40 is used, the marks printed in the left and right margins are the first mark and the second mark illustrated in FIG. 7.

However, when the colorimetry jig 40 is used, the size of the margin may vary depending on the size of the medium, and thus the sizes of the first mark M1 and the second mark M2 may vary depending on the size of the medium. On the other hand, the relative distance among the color chart CC, the first mark M1, and the second mark M2 is the same regardless of the first size and the second size. That is, when the medium size Lp is greater than A-B, the chart size Lct does not change even if the medium size Lp changes, and thus the distance between the color chart CC and the first mark M1 does not change. Similarly, the distance between the color chart CC and the second mark M2 does not change. Similarly, the distance between the first mark M1 and the second mark M2 does not change. Therefore, the operation can be performed at the same interval regardless of the medium size.

When the print data is generated, the processor 10a transmits the print data to the printer 20 and causes the printer 20 to print the colorimetric sheet S (step S140). As a result, the colorimetric sheet S is printed. Since the user can perform color measurement using the colorimetry jig 40, even an unaccustomed user can easily perform the color measurement operation.

In the present embodiment, the color measurement is assumed to be performed with the medium placed at the center of the colorimetry jig 40 in the first direction. However, the position where the medium is placed is not limited. For example, in a case where the size of the medium is large and the color measurement can be performed by moving the colorimeter 30 from one end to the other end in the first direction even if the medium is arranged in a left-aligned manner, as illustrated in FIG. 19, the color chart of the colorimetric sheet S may be determined so as to be arranged in the left-aligned manner.

On the other hand, when it is not determined in step S205 that the medium size Lp is equal to or greater than A-B, the processor 10a generates print data of a colorimetric sheet including a color chart with the maximum number of patches in the first direction (row direction) (step S230). That is, when the medium size Lp is less than A-B, the color measurement can be performed from end to end of the medium without being restricted by the stopper 42. In addition, when the colorimetry jig 40 is used, even an unaccustomed user can perform color measurement without being affected by a step formed by the medium or the like.

Therefore, in the present embodiment, when the medium size Lp is less than A-B, the number of patches in the first direction is maximized. The processing in step S230 is the same as that in the above-described step S130.

Specifically, the processor 10a acquires a chart size Lct in the first direction by subtracting the sensor size Ls×2 of the sensor 30d, which is the minimum margin size at both ends, from the medium size Lp in the first direction Dr. Then, the processor 10a acquires the number of patches in the first direction by dividing the chart size Lct by the patch size in the first direction.

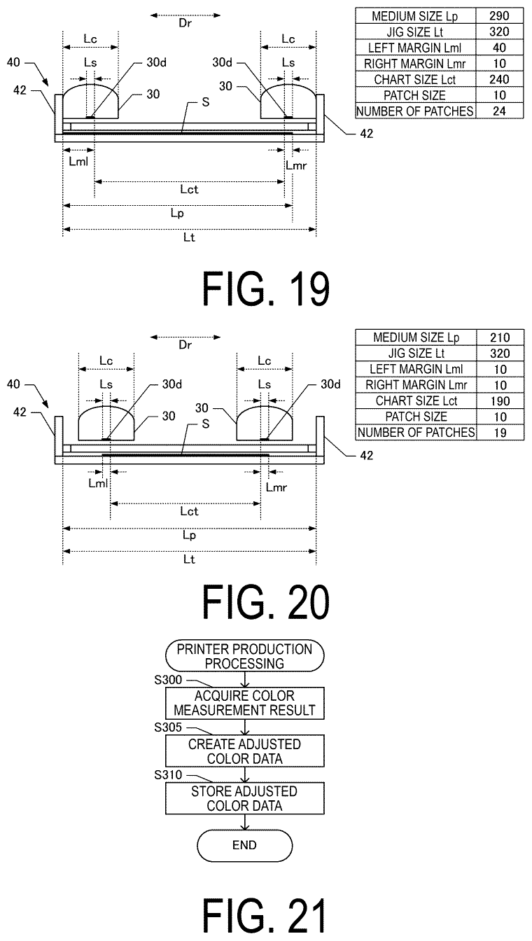

In FIG. 20, an example size is illustrated on the right side. In this example, the medium size Lp is 210 mm. Further, since the sensor size Ls is 10 mm, both a left margin Lml and a right margin Lmr are 10 mm. As a result, the chart size Lct is calculated by 210−10×2 and thus is 190 mm. Since the sensor size Ls is 10 mm and the patch size is 10 mm, the number of patches is 19 (=190/10). As described above, when the size of the medium in the first direction is the third size smaller than A-B, a color chart in which a smaller number of patches are arranged in the first direction than in the case of the second size is printed.

When the number of patches in the first direction is acquired, the processor 10a generates image data for printing with the patches arranged in the arrangement order from the left in the odd-numbered rows and arranged in the arrangement order from the right in the even-numbered rows. The color chart generated as described above is a first pattern in which color measurement starts with the colorimeter 30 protruding beyond the medium in the first direction. According to the first pattern, it is possible to maximize the number of patches arranged in the first direction and to efficiently perform the color measurement operation.

Further, the processor 10a generates print data of the colorimetric sheet S including the color chart. Specifically, the processor 10a generates image data indicating a character to be printed in the margin portion, and combines the image data with the image data of the color chart. Then, the processor 10a generates print data for printing the combined image data.

When the print data is generated, the processor 10a transmits the print data to the printer 20 and causes the printer 20 to print the colorimetric sheet S (step S140). As a result, the colorimetric sheet S in which the number of patches in the row direction is maximized is printed as indicated by the icon Ia shown in the user interface in FIG. 11. Since the user can perform color measurement using the colorimetric sheet S, the color measurement operation can be performed with the number of color measurement patches maximized for each row, and thus can be efficiently performed.

According to the present embodiment described above, the size of the color chart to be printed is changed in accordance with the size of the medium designated by the user. Therefore, in the present embodiment, the size of the color chart is not limited to a predetermined size and can be flexibly changed. In addition, the number of patches included in the color chart can be changed in accordance with a color measurement mode desired by the user. Therefore, it is possible to produce a colorimetric sheet adapted to various needs of the user.

In the present embodiment, when the designation of the automatic colorimeter model is received, a color chart with the maximum number of patches in the first direction (row direction) is printed on the colorimetric sheet S. On the other hand, when the designation of the manual colorimeter model is received, the color chart with the maximum number of patches in the first direction (row direction) or the color chart in which the number of patches is not maximized and which has more margins than the above color chart is printed.

Therefore, in the present embodiment, when designation of a first colorimeter of a model with which color measurement is performed manually is received, printed is a color chart in which the number of patches arranged in the first direction is smaller than in a case where designation of a second colorimeter of a model with which the color measurement is automatically performed. According to this configuration, with the manual colorimeter model, it is possible to produce various colorimetric sheets according to the needs of the user.

### (3) Method of Producing Printer

A printer can be produced using the colorimetric sheet S produced as described above. FIG. 21 is a flowchart illustrating printer production processing. The user measures the colors of the patches included in the color chart CC on the colorimetric sheet S using the colorimeter 30. At this time, the user measures the color of the patches according to a predetermined arrangement order. The colorimeter 30 associates the color measurement result with the identification information of the patch, and stores the resultant colorimetric data 10c2 in the nonvolatile memory 30c. When the color measurement is performed, the processor 10a acquires the color measurement result from the colorimeter 30 (step S300). Specifically, the processor 10a acquires the colorimetric data 10c2 and stores it in the nonvolatile memory 10c.

Next, the processor 10a creates the adjusted color data 10c3 (step S305). Specifically, the gradation value indicating the amount of color material when printing the patches of the color chart CC is stored in the nonvolatile memory 10c in association with the identification information of the patch. Therefore, the processor 10a creates the adjusted color data 10c3 by associating the colorimetric value of each patch with the gradation value indicating the amount of color material, and stores the adjusted color data 10c3 in the nonvolatile memory 10c.

Next, the processor 10a stores the adjusted color data 10c3 in the printer 20 (step S310). Specifically, the processor 10a transmits the adjusted color data 10c3 created in step S305 to the printer 20 to make it stored in the nonvolatile memory 20c. As a result, the printer 20 can perform color conversion with reference to the adjusted color data 10c3 when performing printing. According to the processing described above, it is possible to produce the printer 20 capable of performing printing using the adjusted color data 10c3 for reproducing the color printed using the colorimetric sheet S.

### (4) Other Embodiments

The above embodiment is an example for carrying out the present disclosure, and various other embodiments can be adopted. For example, instead of starting the color measurement from the margin, the color measurement may be started from the patch. In this case, for example, as indicated by the icon Ia illustrated in FIG. 10 and FIG. 11, it is possible to arrange the patches at the positions of the margin instead of the margin formed on the left and right in the first direction.

A mode of a color chart used for color measurement with the colorimetry jig 40 may be selectable. For example, as illustrated in FIG. 20, the above-described embodiment is configured to measure the color of the colorimetric sheet S at the center in the first direction Dr, but may be configured to set the colorimetric sheet S on the colorimetry jig 40 in a left-aligned manner or a right-aligned manner. In this case, at the left end or the right end, the colorimeter 30 needs to be brought into contact with the end of the stopper 42 to perform color measurement, and thus a dead space is generated. Still, the colorimeter 30 can be easily set at the color measurement start position.

Furthermore, a configuration may be employed in which the user selects between printing of the color chart for starting the color measurement with the medium separated from the end of the colorimetry jig 40 in one end portion in the first direction, and printing of the color chart for starting the color measurement with the medium in contact with the colorimetry jig 40. According to this configuration, the user can select whether to print a color chart enabling easier color measurement or a color chart with a larger number of patches in the first direction.

The medium may be any medium as the target of the color chart printing, and size and type of the medium are not limited. At least the first size, the second size, and the third size can be designated as the size of the medium, but the size is not limited to these sizes. For example, it may be possible to designate any size. The type of the medium is not limited, and may be selected according to the purpose of color measurement for the color chart. For example, if the color measurement is performed for the color chart to perform color management when printing is performed on a white medium, the color chart is printed on the white medium. On the other hand, if the color measurement is performed for the color chart to perform color management when printing is performed using a medium of a specific chromatic color, the color chart is printed on the medium of the chromatic color.

The colorimetric sheet may be any medium on which a color chart is printed, and may be printed with another image such as the first pattern. The other image is not limited to the first pattern and the second pattern. For example, information and the like indicating a cutoff line, a colorimeter, a model of a printer, information indicating identification information of a color chart, or the like may be printed. The color chart is a region including a plurality of patches, and the patches are arranged in a two dimensional direction, that is, the first direction and a direction orthogonal to the first direction. The size of the patch is not limited, and any size may be employed as long as color measurement can be performed with the colorimeter.

The colorimetry jig is a tool for assisting color measurement operation using the color measurement device, and has, for example, a mechanism for assistance in making the movement direction of the colorimeter to be a constant direction (first direction). By changing the mechanism in a direction orthogonal to the moving direction of the colorimeter, color measurement can be performed on any patches arranged in two dimensional directions.

The size A of the colorimetry jig may be the maximum size of a medium that can be placed on the colorimetry jig, and may be determined in advance based on the colorimetry jig. The value B corresponding to the size of the colorimeter in the first direction is a value determined by the size of the colorimeter, and is a value for identifying a size in which the color measurement can be performed in the first direction. When the colorimeter is set on the colorimetry jig and moved, the colorimeter can be moved from a state in which the colorimeter is in contact with one end portion in the first direction to a state in which the colorimeter is in contact with the other end portion in the first direction. Therefore, the movement range at this time is the maximum range in which the colorimeter can move in the first direction, and the range in which color measurement can be performed when the colorimeter is moved in this range is the maximum size in which color measurement can be performed in the first direction.

The value B is a value for identifying the maximum size in which color measurement can be performed, and is a value corresponding to the size of the colorimeter in the first direction. That is, at both ends in the first direction, the dead space where color measurement cannot be performed varies depending on the size of the colorimeter in the first direction. Therefore, the dead space may be represented by the value B. The value B may be a value obtained by giving a margin to the size of the colorimeter in the first direction, or may be a value calculated from each size of each unit of the colorimeter in the first direction. In any case, the value B is a value corresponding to the size of the colorimeter in the first direction, and is a value determined by a common rule regardless of the model of the colorimeter. Therefore, when the size of the colorimeter varies depending on the model of the colorimeter, the value B corresponding to the size of the colorimeter also varies depending on the size of the colorimeter.

In a configuration in which the number of patches arranged in the first direction in the color chart is determined by a medium, a method of determining the number of patches changes based on a certain criterion. The criterion may be, for example, size A−size B. In addition, the criterion may be, for example, a size in the first direction measured in a case where the colorimeter is moved in the first direction using the colorimetry jig, and the color measurement starts from one end portion in the first direction and ends at the other end portion.

Furthermore, the above-described system, program, and method may be realized by a single apparatus or may be realized by using components included in a plurality of apparatuses, and include various modes. In addition, the present disclosure can be appropriately changed such that a part is software and a part is hardware. Further, the present disclosure is also realized as a recording medium of a program for controlling the system. As a matter of course, a recording medium for the program may be a magnetic recording medium or a semiconductor memory, and the same applies to any recording medium to be developed in the future.

What is claimed is:

1. A colorimetric sheet production method, comprising:
receiving designation of a size of a medium from among a plurality of sizes including a first size, a second size, and a third size; and
producing a colorimetric sheet by printing, using a printer, a color chart on the medium having the designated size, wherein
when a size of a colorimetry jig in a first direction in which a colorimeter is moved using the colorimetry jig is A, and a value corresponding to a size of the colorimeter is B, and
in a case in which the sizes are, in order from largest, the first size, the second size, A-B, and the third size,
when the size of the medium in the first direction is the first size and the second size, the color chart is printed in which the same number of patches are arranged in the first direction, and
when the size of the medium in the first direction is the third size, the color chart is printed in which the number of the patches arranged in the first direction is smaller than the number in a case of the second size.

2. The colorimetric sheet production method according to claim 1, wherein a size of the patches is same regardless of the size of the medium.

3. The colorimetric sheet production method according to claim 1, further comprising printing, on the medium, a first mark indicating a start position of color measurement using the colorimeter in one end portion in the first direction, and a second mark indicating a start position of color measurement using the colorimeter in another end portion in the first direction, wherein
a relative distance among the color chart, the first mark, and the second mark is same in the first size and in the second size.

4. The colorimetric sheet production method according to claim 1, comprising:
receiving designation of a model of the colorimetry jig; and
determining A which is the size of the colorimetry jig, based on the model of the colorimetry jig.

5. The colorimetric sheet production method according to claim 1, comprising:
receiving designation of a model of the colorimeter; and
determining B which is the value corresponding to the size of the colorimeter, based on the model of the colorimeter.

6. The colorimetric sheet production method according to claim 5, comprising, when designation of a first colorimeter of a model with which color measurement is manually performed is received, printing the color chart in which the number of patches arranged in the first direction is equal to or smaller than the number in a case where designation of a second colorimeter of a model with which the color measurement is automatically performed.

7. The colorimetric sheet production method according to claim 1, comprising causing a user to select between a first pattern in which color measurement starts with the colorimeter protruding from the medium in the first direction, and a second pattern in which the color measurement is able to be started without the colorimeter protruding from the medium.

8. The colorimetric sheet production method according to claim 1, comprising causing a user to select between printing of the color chart in which the medium is moved away from an end of the colorimetry jig in one end portion in the first direction to start the color measurement, and printing of the color chart in which the medium is brought into contact with the colorimetry jig to start the color measurement.

9. A colorimetric sheet production method, comprising:
receiving designation of a size of a medium from among a plurality of sizes including a first size, a second size, and a third size; and
producing a colorimetric sheet by printing, using a printer, a color chart on the medium having the designated size, wherein a size of color measurement in a first direction, in which a colorimeter is moved using a colorimetry jig, when the color measurement is started from one end portion in the first direction and ended at another end portion in the first direction is a threshold value,
in a case in which the sizes are, in order from largest, the first size, the second size, the threshold value, and the third size,
when the size of the medium in the first direction is the first size and the second size, the color chart is printed in which the same number of patches are aligned in the first direction, and
when the size of the medium in the first direction is the third size, the color chart is printed in which the number of the patches arranged in the first direction is smaller than the number in a case of the second size.

10. A printer production method, comprising:
receiving designation of a size of a medium from among a plurality of sizes including a first size, a second size, and a third size;
producing a colorimetric sheet by printing, using a printer, a color chart on the medium having the designated size;
causing a user to manually perform color measurement on the color chart of the colorimetric sheet;
creating adjusted color data based on a result of the color measurement; and
storing the adjusted color data in the printer, wherein
when a size of a colorimetry jig in a first direction in which a colorimeter is moved using the colorimetry jig is A, and a value corresponding to a size of the colorimeter is B, and
in a case in which the sizes are, in order from largest, the first size, the second size, A-B, and the third size,
when the size of the medium in the first direction is the first size and the second size, the color chart is printed in which the same number of patches are arranged in the first direction, and
when the size of the medium in the first direction is the third size, the color chart is printed in which the number of patches arranged in the first direction is smaller than the number in a case of the second size.

11. A non-transitory computer-readable storage medium storing a colorimetric sheet production program causing a computer to function to:
receive designation of a size of a medium from among a plurality of sizes including a first size, a second size, and a third size; and
produce a colorimetric sheet by printing, using a printer, a color chart on the medium having the designated size, wherein
when a size of a colorimetry jig in a first direction in which a colorimeter is moved using the colorimetry jig is A, and a value corresponding to a size of the colorimeter is B, and
in a case in which the sizes are, in order from largest, the first size, the second size, A-B, and the third size,
when the size of the medium in the first direction is the first size and the second size, the color chart is printed in which the same number of patches are arranged in the first direction, and
when the size of the medium in the first direction is the third size, the color chart is printed in which the number of patches arranged in the first direction is smaller than the number in a case of the second size.

12. A non-transitory computer-readable storage medium storing a colorimetric sheet production program causing a computer to function to:
receive designation of a size of a medium from among a plurality of sizes including a first size, a second size, and a third size; and
produce a colorimetric sheet by printing, using a printer, a color chart on the medium having the designated size, wherein
a size of color measurement in a first direction, in which a colorimeter is moved using a colorimetry jig, when the color measurement is started from one end portion in the first direction and ended at another end portion in the first direction is a threshold value,
in a case in which the sizes are, in order from largest, the first size, the second size, the threshold value, and the third size,
when the size of the medium in the first direction is the first size and the second size, the color chart is printed in which the same number of patches are arranged in the first direction, and
when the size of the medium in the first direction is the third size, the color chart is printed in which the number of the patches arranged in the first direction is smaller than the number in a case of the second size.

13. A non-transitory computer-readable storage medium storing a printer production program causing a computer to function to:
receive designation of a size of a medium from among a plurality of sizes including a first size, a second size, and a third size;
produce a colorimetric sheet by printing, using a printer, a color chart on the medium having the designated size;
cause a user to manually perform color measurement on the color chart of the colorimetric sheet;
create adjusted color data based on a result of the color measurement; and
store the adjusted color data in the printer, wherein
when a size of a colorimetry jig in a first direction in which a colorimeter is moved using the colorimetry jig is A, and a value corresponding to a size of the colorimeter is B, and
in a case in which the sizes are, in order from largest, the first size, the second size, A-B, and the third size,
when the size of the medium in the first direction is the first size and the second size, the color chart is printed in which the same number of patches are arranged in the first direction, and
when the size of the medium in the first direction is the third size, the color chart is printed in which the number of the patches arranged in the first direction is smaller than the number in a case of the second size.
